(19) United States
(12) Patent Application Publication
(10) Pub. No.: US 2025/0115506 A1
(43) Pub. Date: Apr. 10, 2025

(54) Parallel Supercritical Water Oxidation (SCWO) Reactors with External Heating and Methods of Destroying PFAS

(71) Applicant: Revive Environmental Technology, LLC, Columbus, OH (US)

(72) Inventors: Lindy Espina Dejarme, Columbus, OH (US); Amira Rasoul, Columbus, OH (US); Stephen H. Rosanksy, Tampa, FL (US)

(21) Appl. No.: 18/677,858

(22) Filed: May 29, 2024

Related U.S. Application Data
(60) Provisional application No. 63/504,757, filed on May 29, 2023.

(51) Int. Cl. C02F 11/08; C02F 1/72; C02F 1/74; C02F 101/36

(52) U.S. Cl. CPC C02F 11/086; C02F 1/722; C02F 1/727; C02F 1/74; C02F 2101/36; C02F 2201/003; C02F 2201/008; C02F 2301/04; C02F 2305/023

(57) ABSTRACT

Methods and systems of destroying PFAS utilize a jacketed reactor for supercritical water oxidation (SCWO). Inside the jacket, fuel and an oxidant are combined to provide heat for startup and operation of the SCWO reactor. The jacketed reactors can be operated in parallel and in mobile systems that can fit in a trailer for transportation and operation at a site that has PFAS contaminated water.

### RELATED APPLICATIONS

This application claims the priority benefit of U.S. Provisional Patent Application Ser. No. 63/504,757 filed 29 May 2023.

### INTRODUCTION

Per- and polyfluoroalkyl substances (PFAS), including perfluorooctane sulfonate (PFOS) and perfluorooctanoic acid (PFOA), and hundreds of other similar compounds, have been widely used in the United States in a multitude of applications. There are significant concerns associated with these compounds due to widespread contamination coupled with uncertainties about risks to human health and the environment. PFAS are molecules having chains of carbon atoms surrounded by fluorine atoms. The C—F bond is very stable enabling the compounds to persist in the natural environment. Some PFAS include hydrogen, oxygen, sulfur, phosphorus, and/or nitrogen atoms. One example is PFOS:

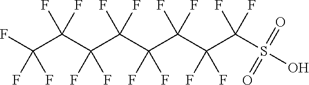 [SMILES: O=S(=O)(O)C(F)(F)C(F)(F)C(F)(F)C(F)(F)C(F)(F)C(F)(F)C(F)(F)C(F)(F)F]

Although some PFAS compounds with known human health risks have been voluntarily phased out (PFOA and PFOS), legacy contamination remains. Replacement PFAS compounds have been introduced with limited understanding of their health risks. Currently, only PFOA and PFOS are addressed in Lifetime Health Advisories at the Federal level, with no established maximum contaminant level (MCL) to regulate the acceptable level of these and other PFAS compounds in drinking water. PFAS contamination in drinking water sources in 1,582 locations in 49 states as of May 2020. Currently used techniques for treating PFAS-contaminated water are expensive, and management of spent media is costly and may result in long-term liability.

### Supercritical Water Oxidation (SCWO)

The destruction of PFAS via Supercritical Water Oxidation (SCWO) has been described by Rosansky et al. in U.S. Pat. No. 11,407,666 which is incorporated herein as if reproduced in full below. The operating conditions of a SCWO continuous method and reactor (hereafter referred to as PFAS Annihilator™) have been developed and found to have several benefits for environmental remediation and waste management industries. The PFAS Annihilator™ consistently achieves near-complete destruction of PFAS, bringing the concentrations down to non-detect for most target PFAS, and consistently down to less than 70 ppt (parts per trillion) for all PFAS in under 30 seconds. This technology can be used to treat material contaminated with PFAS and other substances such as petroleum hydrocarbons or chlorinated solvents, which are also readily oxidized. Moreover, SCWO can be applied to a variety of PFAS-impacted liquids such as AFFF, landfill leachate, and investigation derived waste (IDW) due to its non-targeted carbon-fluorine bond destruction. The treated effluent is largely comprised of the products of complete combustion including carbon dioxide and water, and the corresponding anion acids; hence, the treated liquid can be released back into the environment after neutralization.

### SUMMARY OF THE INVENTION

In a first aspect, the invention provides a method of destroying PFAS in a mobile apparatus comprising: a plurality of SCWO reactors wherein each reactor further comprises: a reactor tube; and a concentric heating jacket; the plurality of reactors arranged in a mobile trailer, preferably a typical truck trailer; pretreating a stream of PFAS-contaminated water before and/or during passage through the plurality of reactors; adding an oxidant to the stream of PFAS-contaminated water; passing a stream of PFAS-contaminated water through the plurality of reactors; passing a stream of an oxidizable fuel and oxidant mixture through the heating jacket; igniting the stream of fuel and oxidant mixture to cause combustion of the fuel; and allowing heat from the combustion of the fuel in the heating jacket to heat the stream of PFAS-contaminated water to desired reactive conditions.

In another aspect, the invention provides a method of starting up a reactor comprising: a SCWO reactor further comprising: a reaction tube; and a concentric heating jacket; adding an oxidizable fuel and oxidant mixture to the heating jacket; using an external heat source to bring the fuel to an autoignition temperature; and allowing the fuel to combust upon reaching the autoignition temperature.

In a further aspect, the invention provides a SCWO reactor comprising: a reaction tube; and a concentric heating jacket wherein a fuel is combusted to provide heat. The invention also provides an apparatus comprising a plurality of SCWO reactors arranged within a mobile trailer.

In another aspect, the invention provides a system for the destruction of PFAS comprising: a plurality of SCWO reactors, each reactor further comprising: a reactor; and a concentric heating jacket; wherein the reactors are arranged inside a typical truck trailer; an external heat source disposed about each heating jacket; a stream of PFAS-contaminated water being fed into the SCWO reactors; a line adding an oxidant to the stream of PFAS-contaminated water; a line adding an oxidant and a fuel in the heating jacket; a vapor stream of products exiting the reactor tubes; and a vapor stream of products exiting the heating jackets.

In a further aspect, the invention provides a method of destroying PFAS comprising: pretreating a PFAS-contaminated aqueous stream; adding an oxidant to the pretreated PFAS-contaminated aqueous stream before and/or during passage through a SCWO reactor, wherein the reactor further comprises: a reactor tube; and a heating jacket; passing a stream of an oxidizable fuel and oxidant mixture through the heating jacket; igniting the stream of fuel and oxidant mixture to cause combustion of the fuel; adding a sample of the PFAS-contaminated aqueous stream, pretreated or untreated, to the reactor; and allowing heat from the combustion of the fuel in the heating jacket to heat the sample to desired conditions; wherein the sample is subjected to oxidation under supercritical conditions.

In another aspect, the invention provides a method of starting up a plurality of SCWO reactors, comprising: arranging the reactors in parallel to one another; igniting an oxidizable fuel and oxidant mixture in a first reactor; allowing heat from the first reactor to ignite a second reactor; and allowing heat from the second reactor to ignite the fuel in a third reactor and so on until all reactors have been ignited.

Any of the inventive aspects can be further characterized by any of the features described in this specification, for example, any variation of configuration of a plurality of reactors and jacketed heat exchangers. Any of the inventive aspects can be further characterized by one or any combination of the following: wherein the plurality of SCWO reactors is arranged in parallel; wherein the SCWO reactor comprises a first reactor tube and a first concentric heating jacket surrounding the first reactor tube wherein the first concentric heating jacket is connected to and adapted to be heated by the external heat source; and further comprising a second reactor tube and a second concentric heating jacket surrounding the second reactor tube; wherein the first and second reactor tubes operate in parallel and the first and second concentric heating jackets operate in series, and wherein the second concentric heating jacket is not connected to and not adapted to be heated by an external heat source and wherein, second concentric heating jacket heated from product gases from the first concentric heating jacket; wherein the first reactor tube has a single first inlet and single first outlet and wherein the second reactor tube has a single second inlet and single second outlet; and wherein fluids from the first outlet and second outlet are combined; wherein the rate of destruction of PFAS in a volume of PFAS-contaminated water in the SCWO reactors to the desired level is directly proportional to the the number of reactors arranged in parallel; wherein the fuel and oxidant mixture in the heating jacket is ignited by heating the reactor using an external heat source to an autoignition temperature and allowing the mixture to autoignite; wherein the fuel can be any oxidizable fuel such as C1-C10 alkanes or C1-C10 alcohols, most preferably C2-C6 alcohols with isopropanol being especially preferred; wherein the oxidant in the fuel/oxidant mixture in the heating jacket may be hydrogen peroxide, or oxygen, preferably compressed air in excess, for example at least 1.5× excess or at least 2× excess; wherein the excess heat generated by the combustion of the fuel in the heating jacket is used to preheat water to reactive conditions prior to passage through the reactor; wherein the oxidant for the fuel is added by one line and the oxidant for the aqueous stream is added by a separate line; wherein the fuel can be any oxidizable fuel such as C1-C10 alkanes or C1-C10 alcohols, most preferably C2-C6 alcohols with isopropanol being especially preferred; wherein the oxidant may be hydrogen peroxide, or oxygen, preferably compressed air in excess, for example at least 1.5× excess or at least 2× excess; wherein the vapor stream comprises CO₂, H₂O, typically less than 1 mass % of the vapor of unburnt or partially burnt fuel, and heat; wherein the heat from the vapor stream can be exchanged with upstream components such as salt separators and/or conduits containing the PFAS-contaminated aqueous stream; wherein the heat from the vapor stream may be used to heat water to the SCWO condition and then added to a sample stream for accelerated achievement of SCWO condition in the reactor; wherein the fuel is in the liquid phase; wherein the external heat source is a plurality of resistive heaters; wherein the external heat source is an electrically-heated sand bath; wherein the SCWO reactor comprises a first reaction tube and a first concentric heating jacket surrounding the first reaction tube wherein the first concentric heating jacket is connected to and adapted to be heated by the external heat source; and further comprising a second reaction tube and a second concentric heating jacket surrounding the second reaction tube; wherein the first and second reaction tubes are configured to operate in parallel and the first and second concentric heating jackets are configured to operate in series, and wherein the second concentric heating jacket is not connected to and adapted to be heated by an external heat source and wherein, during startup, the second concentric heating jacket is brought to the autoignition temperature by heat from the first concentric heating jacket; wherein the reaction tube is composed of a superalloy able to resist supercritical conditions; wherein the heating jacket is composed of a superalloy able to resist supercritical conditions; wherein the fuel is any oxidizable fuel such as C₁-C₁₀ alkanes or C₁-C₁₀ alcohols, most preferably C₂-C₆ alcohols, with isopropanol especially preferred; wherein the reactors are arranged in parallel to one another; wherein the PFAS-contaminated aqueous stream is separated into a plurality of parallel streams and each stream is passed through a SCWO reactor; comprising a plurality of SCWO reactors arranged within a mobile trailer; wherein the reactors are arranged in parallel; wherein the mobile trailer is a truck trailer having dimensions of 29 feet (8.8 m) in length or less, 8 ft 6 in (2.6 m) or less width, and 13 ft 6 in (4.1 m) height or less; wherein the fuel is ignited by an external heat source disposed about the heating jacket of the reactor; wherein the heat for the first reactor comes from a dual external heating system comprising a reactor with a heating jacket and a sand bath.

Although the methods are described in reference to PFAS destruction, it can also be applied to destroying other compounds.

Various aspects of the invention are described using the term “comprising;” however, in narrower embodiments, the invention may alternatively be described using the terms “consisting essentially of” or, more narrowly, “consisting of.” All ranges are inclusive and combinable. For example, when a range of “1 to 5′ is recited, the recited range should be construed as including ranges “1 to 4”, “1 to 3”, “1-2”, “1-2 & 4-5”, “1-3 & 5”, “2-5”, any of 1, 2, 3, 4, or 5 individually, and the like.

### Glossary

Hydrothermal oxidation reactions are conducted at a temperature of at least 200° C., or at least 220° C., or at least 250° C., or at least 300° C. so that the materials are in contact for at least 10 seconds or at least 30 seconds or at least 1 minute or at least 10 minutes or at least 30 minutes, or in the range of 10 seconds to one hour.

Oxidants—Typical feedstocks are oxygen gas (O₂) and hydrogen peroxide (H₂O₂). In addition to, or alternative to, these two chemical species, other reactant oxygen sources or oxidizing agents could be added to destroy PFAS in the oxidation reactor. Other oxidants are oxyanion species and peroxy acids. These include, but are not limited to, ferrate salts (FeO₄²⁻), percarbonate salts (ex. C₂K₂O₆), permanganate salts (ex. KMnO₄), potassium peroxymonosulfate (commercially known as Oxone), peroxybenzoic acid, and ozone (O₃). The preferred oxidant is hydrogen peroxide which can be added in excess (for example an excess of at least 50% or at least 100% or in the range of 50% to 300% excess) and the excess hydrogen peroxide reacting to form dioxygen and water.

Per- and polyfluoroalkyl substances (PFAS), including perfluorooctane sulfonate (PFOS) and perfluorooctanoic acid (PFOA), and hundreds of other similar compounds, have been widely used in the United States in a multitude of applications. There are significant concerns associated with these compounds due to widespread contamination coupled with uncertainties about risks to human health and the environment. PFAS are molecules having chains of carbon atoms surrounded by fluorine atoms. The C—F bond is very stable enabling the compounds to persist in the natural environment. Some PFAS include hydrogen, oxygen, sulfur, phosphorus, and/or nitrogen atoms. One example is PFOS:

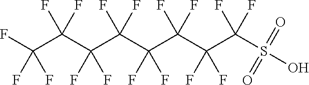 [SMILES: O=S(=O)(O)C(F)(F)C(F)(F)C(F)(F)C(F)(F)C(F)(F)C(F)(F)C(F)(F)C(F)(F)F]

According to the present invention, PFAS-contaminated water has the conventional meaning. The source of the PFAS-contaminated water can be from soil or surface or underground water in areas subjected to PFAS contamination. These areas can be industrial areas, especially where water-proofing or non-stick coatings have been applied. Another common source of PFAS-contaminated water is in areas around airfields or firefighting training areas that have been exposed to AFFF (aqueous film forming foam). Another source can be storage vessels, typically these are accumulated for future destruction or disposal. Typically, there will be non-fluorinated organic compounds present in PFAS-contaminated water and, especially in AFFF residue, there can be chlorinated or brominated compounds.

A system includes apparatus, materials within the apparatus, and, optionally, conditions within the apparatus.

### BRIEF DESCRIPTION OF THE DRAWINGS

FIG. 1 is a schematic illustration of a water pretreatment system for treating PFAS-contaminated water prior to passage through a SCWO reactor.

FIG. 2 schematically illustrates a jacketed SCWO reactor. A fuel such as isopropanol (IPA) and oxidant are combusted within the jacketed region and combustion products exit the jacket.

### DESCRIPTION OF THE INVENTION

The inventive apparatus, systems and methods are designed for destruction of PFAS, especially destruction in mobile apparatus that is sized for transportation and operation in a typical truck trailer. For example, the system can be transported (and optionally operated) on a trailer having dimensions of 29 feet (8.8 m) in length or less, 8 ft 6 in (2.6 m) or less width, and 13 ft 6 in (4.1 m) height or less. The invention also includes methods of starting up a reactor.

A PFAS-contaminated aqueous stream can be pretreated by methods such as concentration in a foam, reverse osmosis followed by salt separation, pre-heating, oxidation, or any pretreatment known in the art. Oxidant is added to the aqueous stream before and/or during passage into the SCWO reactor. The pretreated PFAS-contaminated aqueous stream, optionally after separation into parallel streams such as two, four, or more streams, can be passed into a SCWO reactor, preferably one SCWO reactor for each of streams, where the PFAS-contaminated aqueous stream is subjected to oxidation under supercritical conditions.

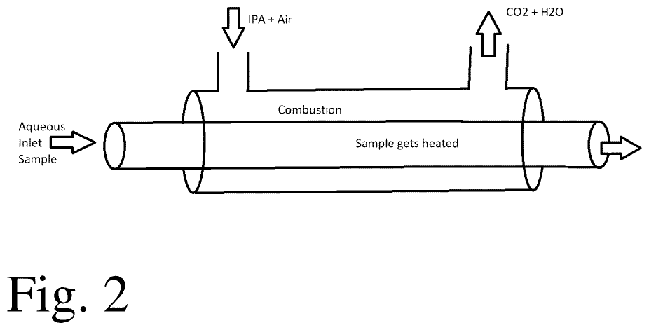

As shown in FIG. 2, the reactor comprises a reaction tube and a concentric heating jacket. At least the reaction tube but typically both the reaction tube and heating jacket are composed of a superalloy able to resist supercritical conditions. Preferably, the reaction tube has an internal diameter of 3 cm or less, more preferably 2 cm or less. Increasing the number of reactors in parallel provides an efficient manner of increasing capacity in a small space, without reducing durability (operation life) of the SCWO reactor. For example, while a single reactor can destroy PFAS to a desired level, adding reactors in parallel allow the volume of PFAS-contaminated water to be destroyed at double the rate, quadruple the rate (four reactors), etc.

In this invention, each SCWO reactor comprises a heating jacket in which a fuel is combusted to provide heat for the SCWO reactor. The fuel can be any oxidizable fuel such as C1-C10 alkanes or C1-C10 alcohols, most preferably C2-C6 alcohols with isopropanol being especially preferred. The alcohols are brought to an autoignition temperature using resistive heaters. Once the autoignition is achieved, combustion of the alcohol is allowed to proceed, and the resistive heaters are turned off. The oxidant can be, but is not limited to, hydrogen peroxide or oxygen, preferably compressed air which is the most economical option. Typically, a liquid fuel is passed through the heating jacket along with compressed air (preferably in excess, for example at least 1.5 excess or at least 2× excess), the fuel combusts in the jacket and products leave the jacket in a vapor stream; typically the product stream comprises CO₂, H₂O, air components, and may contain small amounts (typically less than 1 mass % of the vapor) of unburnt or partially burnt fuel. Heat from the vapor stream can be exchanged with upstream components such as salt separators and/or conduits containing the PFAS-contaminated aqueous stream. Furthermore, the heat generated may be used toward heat water to the SCWO condition and then added to the sample stream for accelerated achievement of SCWO condition in the reactor itself. The required oxygen to transform PFAS into their simplest form under SCWO condition would only be for PFAS only and none for fuel. The required oxygen for fuel is calculated and applied in a different line. Separate oxygen requirements for heating jacket and SCWO reactor make the control of the reactor oxygen, and heating oxygen controlled and efficient without impacting each other. This provides numerous advantages, for example temperature can be maintained while different concentrations of PFAS are fully oxidized within the reactor, and the level of oxidant added to the PFAS-contaminated can be reduced resulting in better controlled SCWO conditions and reduced corrosion.

During startup, a group of parallel reactors could be ignited sequentially in the same manner as one would operate a four-burner grill where a first burner ignites and heat from the first burner used to ignite the other burners in series. While a plurality of SCWO reactors operate in parallel, the heater jackets can operate in series resulting in complete and efficient fuel combustion while reducing materials and system complexity in a multi-reactor system. If desired, the series-connected jackets could be configured with additional fuel and/or oxidizer inlets into the jacketed regions for controlling heat along the series of reactors. For example, if three SCWO reactors are configured to operate in parallel, each SCWO reactor will have an inlet and an outlet, the first reactor has a heater jacket having a fuel inlet an oxidant inlet (or a fuel and oxidant inlet) and a product outlet connected to an inlet of a second jacketed heater disposed about a second SCWO reactor, the second jacketed heater having an one or more inlets for additional fuel and/or oxidant, an outlet from the second reactor connected to the inlet of a third jacketed heater disposed about a third SCWO reactor, the third jacketed heater having an one or more inlets for additional fuel and/or oxidant. In this type of configuration, the first reactor can have the jacketed heater plus a start-up heater such as a resistive heater while the second and third SCWO reactors have only a jacketed heater.

To obtain or maintain high pressure water in the systems, the ignition could be done inside the internal tube and external tube of the first reactor thus providing water in both tubes while the system is heating. The remaining reactors are started/operated serially, similarly to the first reactor. Once the temperature is sufficiently high, internal tubes of the reactor are switched to water only and then to a PFAS-contaminated aqueous stream. A dual external heating system (such as the reactor with heating jacket disposed inside an electrically-heated sand bath) accelerates start-up time while maintaining heat for all reactors without turning off the SCWO halo (the reactive region of the SCWO) while PFAS streams are introduced. A multi-reactor system can be configured so that only a portion (typically only one) of the parallel reactors are fitted with a dual external heating system (for start up) while the other reactors in the system have only a heating jacket.

Heated fluid from the jacketed heater(s) can be passed through a heat exchanger to heat PFAS contaminated water or other fluids in the system prior to the SCWO reactor.

### Illustrated System

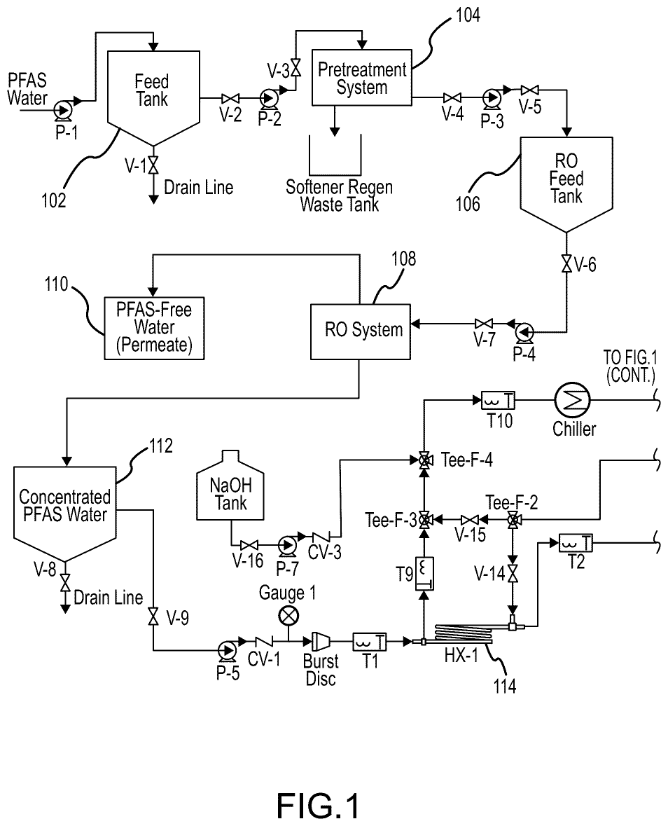

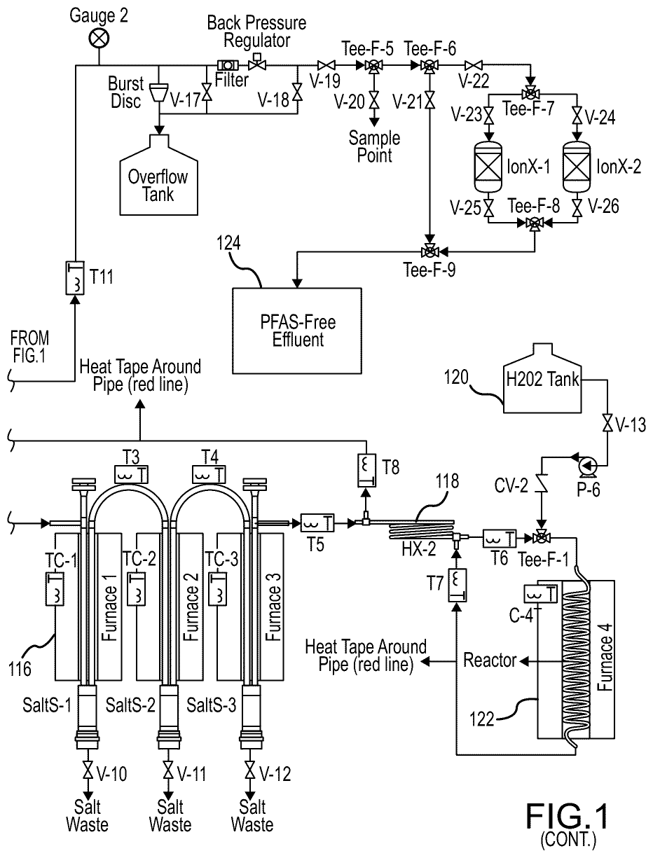

One embodiment of a system for PFAS destruction is schematically illustrated in FIG. 1. PFAS contaminated water entering the system can be subjected to numerous optional pretreatments including one of more of: filtration (not shown) storage in tank 102, a water softening pretreatment 104, a feed tank 106 connected to a reverse osmosis system 108. Water softening to replace other cations with sodium cations can be conducted by conventional means such as passage through an ion exchange resin. The reverse osmosis treatment (described above) produces a permeate 100 having PFAS concentrations that are reduced 10×, 100×, 1000×, 10,000× or more as compared to the PFAS contaminated water entering the system. In some cases, especially with relatively concentrated PFAS solution entering the system, the permeate can be subjected to additional RO treatment to bring the PFAS levels in the permeate down to a low level, such as below 70 ppt, where the water can be released to the environment; the retentate from the additional treatments can be combined with the concentrated solution or combined with incoming PFAS contaminated water such as in tank 102.

The concentrated PFAS water 112 can be passed through optional heat exchanger 114 which can be a tube-in-tube heat exchanger. The concentrated PFAS water 112 passes into salt separator 116. The salt separator can have a plurality of zones that operate at different conditions of temperature or pressure. The tubes can be heated by a tube furnace that surrounds the tubes. In the case of a plurality of vertical tubes (six shown in FIG. 4, three upward and three downward) can have a relatively large inner diameter—for example, at least 1.5 cm or at least 2.0 cm or at least 1 inch (2.4 cm)—to prevent plugging. At the bottom (with respect to gravity) of each salt separator tube is a larger diameter container (collector vessel 220), preferably having an inner diameter of at least 5 cm, or at least 10 cm, or in the range of 5 to 20 cm. Preferably the collection vessel includes a diameter that is at least two times or at least four times larger than the inlet tube. The collection vessel can be heated; for example by electrical tape. The collector vessel(s) connect the inlet and outlet, preferably have a depth of at least 20 cm, or at least 30 cm, or at least 40 cm, and in some embodiments in the range of 25 to 75 cm. Salt forming in the inlet tube falls into the collection vessel where is can be continuously, or more typically, periodically removed and, if necessary, treated to remove PFAS or other contaminants. Toward the bottom of the collector vessels there is preferably a valve leading to a drain to remove brine or a briny slurry that collects at the bottom of the collector vessel. Optionally, a pump assembly can be used to evacuate the contents of the collector vessel at high pressure during operation. In some preferred embodiments, a salt separator tube inlet 222 (carrying fluid into the collector tube) extends into the collector vessel by at least 5 cm or at least 10 cm (relative to the outlet into an upward flowing tube); this enhances downward flow of the saltier fraction into the bottom of the collector tube forcing the lighter fraction out of the outlet 224. The collector vessel(s) may contain baffles to minimize turbulence and mixing near the bottom of the collector vessel(s). Typically, conditions in the bottom of the collection vessel are subcritical.

The concentrated PFAS water 112 typically enters the salt separator at subcritical but preferably near supercritical conditions so that the salt is completely dissolved in the water allowing greater residence time for salt to fall out of solution and fall into the collection vessel. Alternatively, the water 112 can enter the salt separator at supercritical conditions. In the salt separator temperature is increased so that the solution becomes supercritical and sodium chloride and other salts precipitate from solution. Conditions (typically temperature) in successive zones of the salt separator can be controlled so that the salt becomes increasingly insoluble as it travels through the salt separator. In some embodiments, the solution entering the salt separator can be below 370° C. and increased in the range of 375 to 450° C. in the salt separator. Optionally, a fuel, such as an alcohol, could be added prior to or during the salt separation stage in order to increase temperature.

Water can pass through a heat exchanger 118 and then is typically combined with an oxidant 120, such as hydrogen peroxide, prior to introduction into SCWO reactor 144 where any remaining PFAS is destroyed. Although in the figure provided, peroxide (or other oxidant) to be added is introduced immediately before the reactor, there is the option to add the oxidant at various locations, including upstream of the salt separator. The advantages of adding oxidant in a plurality of locations include 1) minimizing the potential for a hot spot at the location where the peroxide is added, and 2) facilitating destruction of PFAS in the salt separator. However, a disadvantage of adding peroxide upstream of the salt separators is that corrosion can be exacerbated. The PFAS-free effluent can be passed through heat exchanger(s) such as 118, 114 to recover heat and then stored or passed out of the system as PFAS-free effluent 124.

Corrosive effluent from the SCWO reactor containing aqueous HF at high temperature (for example, around 600° C.) can flow into a mixing pipe. Cooling water, typically containing hydroxy salts, can be fed into a mixing pipe where it mixes with the corrosive effluent. The cooled effluent contains dissolved fluoride salts such as NaF.

Since the SCWO process destroys essentially all of the PFAS, the treated effluent can be safely released back into the environment. In some embodiments, at least a portion of the effluent is evaporated into the air. Precipitates such as fluoride salts can be filtered or centrifuged from the effluent. PFAS-free effluent can be passed through a heat exchanger where the effluent is cooled by the PFAS-contaminated water flowing into the reactor. If necessary, the effluent may be subjected to treatments such as reverse osmosis and/or other treatments (ion exchange resins or other adsorptive media) to remove metals or other contaminants prior to release or disposal of the effluent.

Leaving the SCWO reactor, the resulting clean water can optionally be passed through adsorbent media such as activated carbon or ion exchange resin and returned to the environment. The clean effluent preferably passes back through the second and first heat exchangers. At any point after the SCWO reactor, the cleaned water is preferably neutralized, such as by addition of sodium hydroxide. Also, if necessary, the cleaned water can be treated (for example to remove Cr or other metals) prior to disposal or return to the environment.

1. A method of destroying PFAS in a mobile apparatus comprising:
a plurality of SCWO reactors wherein each reactor further comprises:
a reactor tube; and
a concentric heating jacket;
the plurality of reactors arranged in a mobile trailer;
pretreating a stream of PFAS-contaminated water before and/or during passage through the plurality of reactors;
adding an oxidant to the stream of PFAS-contaminated water;
passing a stream of PFAS-contaminated water through the plurality of reactors;
passing a stream of an oxidizable fuel and oxidant mixture through the heating jacket;
igniting the stream of fuel and oxidant mixture to cause combustion of the fuel; and
allowing heat from the combustion of the fuel in the heating jacket to heat the stream of PFAS-contaminated water to desired reactive conditions.

2. The method of claim 1 wherein the plurality of SCWO reactors is arranged in parallel.

3. The method of claim 1 wherein the SCWO reactor comprises a first reactor tube and a first concentric heating jacket surrounding the first reactor tube wherein the first concentric heating jacket is connected to and adapted to be heated by the external heat source; and further comprising a second reactor tube and a second concentric heating jacket surrounding the second reactor tube; wherein the first and second reactor tubes operate in parallel and the first and second concentric heating jackets operate in series, and wherein the second concentric heating jacket is not connected to and not adapted to be heated by an external heat source and wherein, second concentric heating jacket heated from product gases from the first concentric heating jacket.

4. The method of claim 1 wherein the first reactor tube has a single first inlet and single first outlet and wherein the second reactor tube has a single second inlet and single second outlet; and wherein fluids from the first outlet and second outlet are combined.

5. The method of claim 1 wherein the rate of destruction of PFAS in a volume of PFAS-contaminated water in the SCWO reactors to the desired level is directly proportional to the number of reactors arranged in parallel.

6. The method of claim 1 wherein the fuel and oxidant mixture in the heating jacket is ignited by heating the reactor using an external heat source to an autoignition temperature and allowing the mixture to autoignite.

7. The method of claim 1 wherein the fuel can be any oxidizable fuel such as C1-C10 alkanes or C1-C10 alcohols, most preferably C2-C6 alcohols with isopropanol being especially preferred.

8. The method of claim 1 wherein the oxidant in the fuel/oxidant mixture in the heating jacket may be hydrogen peroxide, or oxygen, preferably compressed air in excess, for example at least 1.5× excess or at least 2× excess.

9. The method of claim 1 wherein the excess heat generated by the combustion of the fuel in the heating jacket is used to preheat water to reactive conditions prior to passage through the reactor.

10. The method of claim 1 wherein the oxidant for the fuel is added by one line and the oxidant for the aqueous stream is added by a separate line.

11. A method of starting up a reactor comprising:
a SCWO reactor further comprising:
a reaction tube; and
a concentric heating jacket;
adding an oxidizable fuel and oxidant mixture to the heating jacket;
using an external heat source to bring the fuel to an autoignition temperature; and
allowing the fuel to combust upon reaching the autoignition temperature.

12. The method of claim 11 in which the fuel can be any oxidizable fuel such as C1-C10 alkanes or C1-C10 alcohols, most preferably C2-C6 alcohols with isopropanol being especially preferred.

13. The method of claim 12 in which the oxidant may be hydrogen peroxide, or oxygen, preferably compressed air in excess, for example at least 1.5× excess or at least 2× excess.

14. The method of claim 11 in which the vapor stream comprises CO₂, H₂O, typically less than 1 mass % of the vapor of unburnt or partially burnt fuel, and heat.

15. The method of claim 14 in which the heat from the vapor stream can be exchanged with upstream components such as salt separators and/or conduits containing the PFAS-contaminated aqueous stream.

16. The method of claim 14 in which the heat from the vapor stream may be used to heat water to the SCWO condition and then added to a sample stream for accelerated achievement of SCWO condition in the reactor.

17. The method of claim 11 in which the fuel is in the liquid phase.

18. The method of claim 11 wherein the external heat source is a plurality of resistive heaters.

19. The method of claim 11 wherein the external heat source is an electrically-heated sand bath.

20. The method of claim 11 wherein the SCWO reactor comprises a first reaction tube and a first concentric heating jacket surrounding the first reaction tube wherein the first concentric heating jacket is connected to and adapted to be heated by the external heat source; and further comprising a second reaction tube and a second concentric heating jacket surrounding the second reaction tube; wherein the first and second reaction tubes are configured to operate in parallel and the first and second concentric heating jackets are configured to operate in series, and wherein the second concentric heating jacket is not connected to and adapted to be heated by an external heat source and wherein, during startup, the second concentric heating jacket is brought to the autoignition temperature by heat from the first concentric heating jacket.

21.-24. (canceled)

25. A system for the destruction of PFAS comprising:
a plurality of SCWO reactors, each reactor further comprising:
a reactor; and
a concentric heating jacket;
wherein the reactors are arranged inside a typical truck trailer;
an external heat source disposed about each heating jacket;
a stream of PFAS-contaminated water being fed into the SCWO reactors;
a line adding an oxidant to the stream of PFAS-contaminated water;
a line adding an oxidant and a fuel in the heating jacket;
a vapor stream of products exiting the reactor tubes; and
a vapor stream of products exiting the heating jackets.

26.-34. (canceled)
